(19) United States
(12) Patent Application Publication
(10) Pub. No.: US 2010/0180526 A1
(43) Pub. Date: Jul. 22, 2010

(54) TRIMMABLE COMPOSITE DOOR

(75) Inventors: Pao Yu An, Tustin, CA (US); Jared Garrett, Mentor, OH (US)

Correspondence Address: DUANE MORRIS LLP - Philadelphia;IP DEPARTMENT, 30 SOUTH 17TH STREET, PHILADELPHIA, PA, 19103-4196, US

(73) Assignee: Plastpro 2000, Inc., Los Angeles, CA (US)

(21) Appl. No.: 12/688,119

(22) Filed: Jan. 15, 2010

Related U.S. Application Data
(60) Provisional application No. 61/145,278, filed on Jan. 16, 2009.

(51) Int. Cl. E06B 3/277; E06B 3/267; E04C 2/20; E04C 2/22

(52) U.S. Cl. 52/309.4; 52/784.15; 52/656.4; 52/309.15

(57) ABSTRACT

A trimmable door is disclosed comprising a pair of horizontal rails, a pair of vertical stiles, first and second door skins, and a foam core. The first and second stiles are made from a composite material that is easily trimmed to enable the door to be custom fit to the unique shape and dimensions of a particular door frame opening, such as is common in the renovation market. The first and second rails also may be made from a trimmable composite material. To provide an additional measure of adjustability, the first and second door skins may also be trimmable. The first and second door skins may be compression molded and have a texture and grain approaching that of wood. The foam core may be a foamed-in-place polyurethane material. The composite material used to form the first and second stiles may be a co-extrusion material of polymer and wood flour.

### CROSS-REFERENCE TO RELATED APPLICATIONS

This is a non-provisional of co-pending US provisional patent application Ser. No. 61/145,278, filed Jan. 16, 2009, the entirety of which application is incorporated by reference herein.

### FIELD OF THE INVENTION

The disclosure relates to replacement door products in general, and more particularly to a trimmable composite door product for use in commercial and residential remodeling applications.

### BACKGROUND

Residential exterior doors have traditionally been fabricated from wood. Wood, however, can have less than desired insulating characteristics, and may also tend to warp over time. More recently, insulated metal faced doors have experienced increasing usage for residential applications since such doors may include insulating cores limiting heat loss and since they also provide greater security and resistance to surface damage. Metal faced doors suffer from the problem that they often can not be used in replacement applications where it is often necessary to custom fit the door to the frame, since the hinges and latch must be matched and the existing door frame may be skewed. Thus, trimming has been an important aspect of fitting replacement doors and such trimming is not feasible with conventional metal faced doors.

Thus, there is a need for an improved door design that overcomes the problems inherent with wood and metal faced door designs, namely that has good insulation characteristics, resists warping, and permits trimming to fit existing door frame installations.

### SUMMARY

A trimmable door assembly is disclosed. The door assembly may comprise a frame having first and second rails, and first and second stiles. First and second skin members may be engaged with the first and second rails and first and second stiles, and a foam core may be disposed between the first and second skin members, the first and second rails, and the first and second stiles. The first and second stiles and first and second skin members may be made from a trimmable composite material.

A trimmable door assembly is disclosed. The door assembly may comprise a frame having first and second rails, first and second stiles, and first and second skin members engaged with the first and second rails and first and second stiles. A foam core may be disposed between the first and second skin members, the first and second rails, and the first and second stiles. The first and second stiles may be made from a trimmable composite material.

A trimmable door assembly is disclosed. The door assembly may comprise a frame having first and second rails, first and second composite stiles, and first and second skin members engaged with the first and second rails and first and second stiles. A foam core may be disposed between the first and second skin members, the first and second rails, and the first and second stiles. The first and second skin members are made from a trimmable composite material.

### BRIEF DESCRIPTION OF THE DRAWINGS

The accompanying drawings illustrate preferred embodiments of the invention so far devised for the practical application of the principles thereof, and in which:

FIG. 1 is a top plan view of the disclosed trimmable composite door;

FIG. 2 is a cross section view of the door of FIG. 1 taken along line 2-2;

FIG. 3 is a cross section view of the door of FIG. 1 taken along line 3-3;

FIG. 4 is a cross section view of the door of FIG. 1 taken along line 4-4;

FIG. 5 is a cross section view of the door of FIG. 1 taken along line 5-5; and

FIG. 6 is a cross section view of the door of FIG. 1 taken along line 6-6.

### DETAILED DESCRIPTION

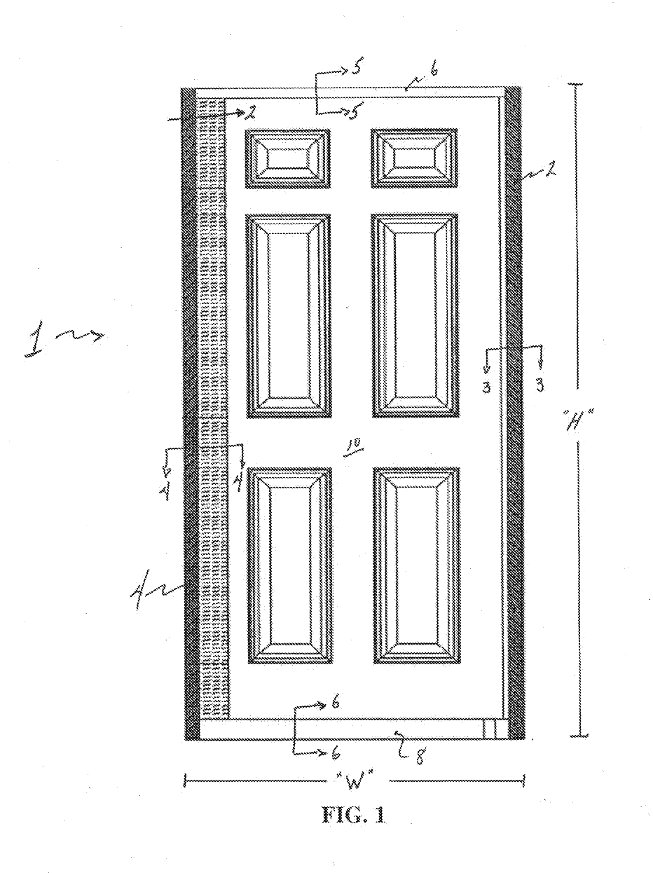

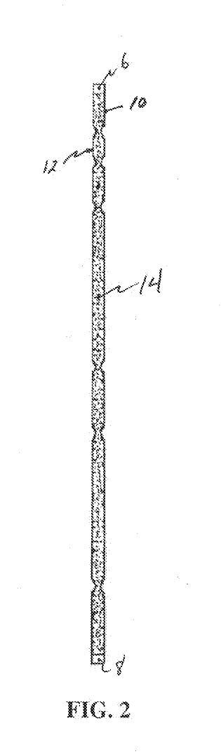

Referring to FIGS. 1 and 2, a composite door 1 comprises first and second vertical stiles 2, 4, a pair of horizontal rails 6, 8, a pair of composite door panels or skins 10, 12 and a foam core 14 disposed between the skins 10, 12, the stiles 2, 4 and the rails 6, 8. The door may have a width “W” and a height “H” sized generally to fit within an opening formed by a doorframe of a residential or commercial building.

The first vertical stile 2 is often referred to as the “hinge stile,” as it may be the stile to which the hinges are fixed. Likewise, second vertical stile 4 is often referred to as the “strike stile,” as it may be the stile to which the door knob and latch or strike are affixed.

Referring now to FIG. 3, the first vertical stile 2 comprises first and second portions 16, 18, and is sized to receive the leaves of typical door hinges. The first portion 16 may be formed from a composite material such as a polymer. In one embodiment, the first portion 16 is formed from a co-extrusion of polymer and wood flour. This first portion 16 may have a width “W1” of about 1″ to about 2″, and in one exemplary embodiment the width “W1” is about 1.42″. The first portion 16 should be trimmable to enable an installer to adjust the final width “W” of the door 1 to fit within the opening of an associated door frame using standard carpentry tooling such as saws, rasps and planes.

The second portion 18 may be formed from a composite material similar to that used to form the first portion 16, or it may be formed from a different material such as Engineered Wood.

The first and second portions 16, 18 may be joined together along a common plane 20 using any of a variety of techniques. In one embodiment, the first and second portions 16, 18 are glued together. In an alternative embodiment, the first and second portions 16, 18 may comprise a single piece of material.

The first stile 2 may additionally have a plurality of skin-engaging recesses 22 configured to receive a bead of adhesive material (not shown) to fix the stile 2 to the associated door skin 10, 12.

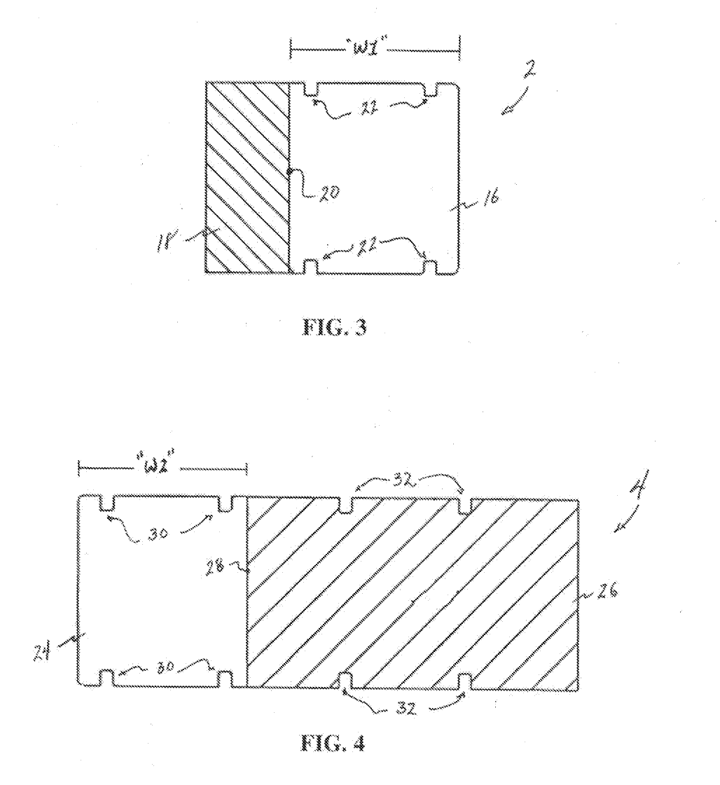

Referring to FIG. 4, the second vertical stile 4 comprises first and second portions 24, 26, and is sized to receive a door knob assembly and latch or strike. The first portion 24 may be formed from a composite material such as a polymer. In one embodiment, the first portion 24 is formed from a co-extrusion of polymer and wood flour. This first portion 24 may have a width “W2” of from about 1″ to about 2″, and in one exemplary embodiment the width “W2” may be about 1.42″. The first portion 24 should be trimmable to enable an installer to adjust the overall width “W” of the door 1 to fit within the opening of an associated door frame using standard carpentry tooling such as saws, rasps and planes.

The second portion 26 may be formed from a composite material similar to that used to form the first portion 24, or it may be formed from a different material such as Engineered Wood.

The portions 24, 26 may be joined together along common plane 28 using any of a variety of techniques. In one embodiment, the first and second portions 24, 26 are glued together. In an alternative embodiment, the first and second portions 24, 26 may comprise a single piece of material.

This second stile 4 may have a plurality of skin-engaging recesses 30, 32 formed in the first and second portions 24, 26, respectively. These recesses may be configured to receive a bead of adhesive material (not shown) to fix the stile 4 to the associated door skin 10, 12.

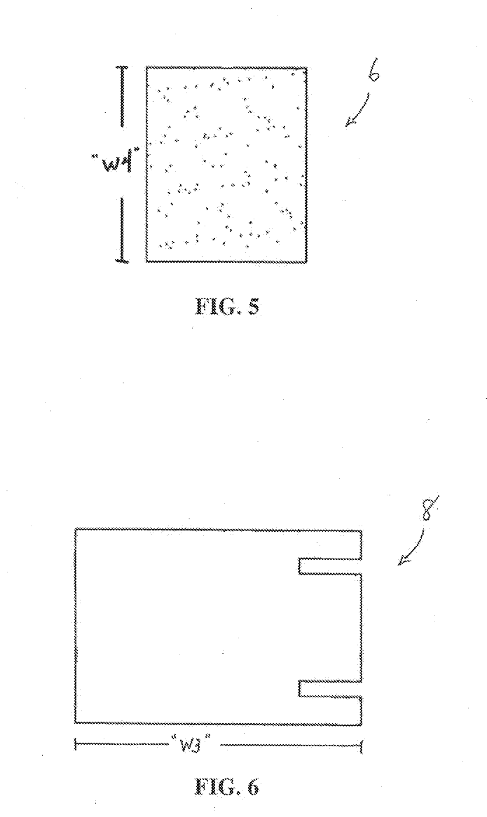

Referring now to FIGS. 5 and 6, horizontal rail 6 may form the top of the door 1, while horizontal rail 8 may form the bottom of the door 1. These horizontal rails 6, 8 may be joined to the first and second vertical stiles 2, 4 by any of a variety of mechanical or chemical joining techniques, such as mechanical fastening, bonding, glue, and the like. The horizontal rails 6, 8 may comprise wood flour, polymer or a combination of the two. In one embodiment the horizontal rails 6, 8 comprise polyvinylchloride (PVC) and wood flour.

The horizontal rail 8 that forms'the bottom of the door 1 may be trimmable in the manner described in relation to the first and second stiles 2, 4. Thus, the horizontal rail 8 may have a width “W3” of from about 2″ to about 3″, and in one exemplary embodiment the width “W3” is about 2.5″. This enables an installer to adjust the overall height “H” of the door 1 to fit within the opening of an associated door frame using standard carpentry tooling such as saws, rasps and planes.

Horizontal rail 6, which forms the top of the door 1, may also be trimmable, and may have a width “W4” of from about 1″ to about 2″, and in one exemplary embodiment the width “W4” may be about 1.585″. The ends of the horizontal rails 6, 8 may also be trimmable (by about 1.25″ on each end) to enable the rails 6, 8 to be trimmed along with the associated stiles 2, 4.

Door skins 10, 12 (FIGS. 1 and 2) may be formed using a compression molding technique to achieve a simulated wood texture and grain on their exterior surfaces. The door skins may be made from a thermoset or thermoplastic material, and may include one or more additives. A non-limiting listing of appropriate materials includes polypropylene, polyester, styrene and polystyrene. Additives such as calcium carbonate, chopped fiber strands (e.g., glass fiber), and pigments may also be used to provide a desired strength, rigidity and/or color. The door skins 10, 12 may be firmly adhered or bonded to the stiles 2, 4 rails 6, 8 and core 14 by means of an adhesive.

In one embodiment, the door skins 10, 12 comprise a material that can be trimmed along with the associated vertical stile 2, 4 to adjust the overall width “W” of the door 1 so that it can fit within the opening of an existing door frame. This enables the installer to make substantial adjustments in the width “W” of the door 1 to fit the door to the unique dimensions of a particular door frame opening. As previously noted, such flexibility enables the door 1 to be custom-fit to door openings in older buildings which often have irregular (e.g. non-standard or non-square) dimensions.

The foam core 14 may be comprised of a foam material that fills the interior of the door 1. The foam core 14 may be selected to provide acoustic and/or thermal insulation properties. The foam core 14 may comprise any of a variety of rigid plastic foams, and in one embodiment, the foam core 14 comprises a polyurethane material. In another embodiment, the foam core 14 may comprise styrene foam. The foam core 14 may be preformed and then inserted into the space between the skins, or it may be foamed-in-place. The foam core 14 functions both as insulation and to add strength and stiffening to the door assembly.

To install the door 1, an old door may be initially removed from the targeted door frame and the replacement door 1 placed into the door frame opening. While removing the old door, the door hinges may be left in position on the door jamb and the positions of the hinges may be marked on the stile 2 of the replacement door 1. The stile 2 may be routed to receive the leaves of the hinges and the door 1 may then be mounted to the door frame opening.

The door 1 may be moved in the closing direction so that the installer can note areas of interference between the door 1 and the door jambs, header and/or floor. Once the areas of interference have been determined, the door 1 may be removed from the door frame opening and the interfering portions of the stiles 2, 4, rails 6, 8, and skins 10, 12 may be trimmed as desired by planning, rasping, sawing and the like. This process may be repeated several times until the door 1 smoothly moves into the closed position with respect to the door frame.

It should be understood that the embodiments disclosed herein are merely illustrative of the principles of the invention. Various other modifications may be made by those skilled in the art which will embody the principles of the invention and fall within the spirit and the scope thereof.

What is claimed is:

1. A trimmable door assembly, comprising:
a frame having first and second rails, and first and second stiles;
first and second skin members engaged with the first and second rails and first and second stiles; and
a foam core disposed between the first and second skin members, the first and second rails, and the first and second stiles;
wherein the first and second stiles and first and second skin members are made from a trimmable composite material.

2. The trimmable door assembly of claim 1, wherein the first and second stiles comprise a first polymer and the first and second skin members comprise a second polymer having a formulation that is different from that of the first polymer.

3. The trimmable door assembly of claim 1, wherein the first and second stiles each comprise a trimmable portion, the trimmable portion having a width of about 1-inch to about 3-inches.

4. The trimmable door assembly of claim 3, wherein the trimmable portion of the first and second stiles comprises a co-extrusion of polymer and wood flour.

5. The trimmable door assembly of claim 1, wherein at least one of the first and second rails comprises a trimmable composite material.

6. The trimmable door assembly of claim 1, wherein the first and second skin members comprise a compression molded polymer.

7. The trimmable door assembly of claim 1, wherein first and second skin members comprise plastic or polymer glass fiber reinforced door skins.

8. The trimmable door assembly of claim 7, wherein the first and second skin members further comprise a material selected from the list consisting of calcium carbonate, chopped fiber strands, and pigment.

9. The trimmable door assembly of claim 1, wherein the foam core comprises a foamed-in-place material.

10. The trimmable door assembly of claim 1, wherein the foam core comprises polyurethane or styrene foam.

11. The trimmable door assembly of claim 1, wherein the first and second stiles each comprises a plurality of recesses configured to receive respective beads of adhesive material to adhere the first and second stiles to the first and second skin members.

12. A trimmable door assembly, comprising:
a frame having first and second rails, first and second stiles, and first and second skin members engaged with the first and second rails and first and second stiles; and
a foam core disposed between the first and second skin members, the first and second rails, and the first and second stiles;
wherein the first and second stiles are made from a trimmable composite material.

13. The trimmable door assembly of claim 12, wherein the first and second stiles comprise a first polymer and the first and second skin members comprise a second polymer having a formulation that is different from that of the first polymer.

14. The trimmable door assembly of claim 12, wherein the first and second stiles each comprise a trimmable portion, the trimmable portion having a width of about 1.42″.

15. The trimmable door assembly of claim 14, wherein the trimmable portion of the first and second stiles comprises a co-extrusion of polymer and wood flour.

16. The trimmable door assembly of claim 12, wherein at least one of the first and second rails comprises a trimmable composite material.

17. The trimmable door assembly of claim 12, wherein the first and second skin members comprise a compression molded polymer.

18. The trimmable door assembly of claim 12, wherein first and second skin members comprise plastic or polymer glass fiber reinforced door skins.

19. The trimmable door assembly of claim 18, wherein the first and second skin members further comprise a material selected from the list consisting of calcium carbonate, chopped fiber strands, and pigment.

20. The trimmable door assembly of claim 12, wherein the foam core comprises a foamed-in-place material.

21. The trimmable door assembly of claim 12, wherein the foam core comprises polyurethane or styrene foam.

22. The trimmable door assembly of claim 12, wherein the first and second stiles each comprises a plurality of recesses configured to receive respective beads of adhesive material to adhere the first and second stiles to the first and second skin members.

23. A trimmable door assembly, comprising:
a frame having first and second rails, first and second composite stiles, and first and second skin members engaged with the first and second rails and first and second stiles; and
a foam core disposed between the first and second skin members, the first and second rails, and the first and second stiles;
wherein the first and second skin members are made from a trimmable composite material.

24. The trimmable door assembly of claim 23, wherein the first and second composite stiles comprise a first polymer and the first and second skin members comprise a second polymer having a formulation that is different from that of the first polymer.

25. The trimmable door assembly of claim 23, wherein the first and second composite stiles each comprise a trimmable portion, the trimmable portion having a width of about 1-inch to about 3-inches.

26. The trimmable door assembly of claim 25, wherein the trimmable portion of the first and second composite stiles comprises a co-extrusion material of polymer and wood flour.

27. The trimmable door assembly of claim 23, wherein at least one of the first and second rails comprises a trimmable composite material.

28. The trimmable door assembly of claim 23, wherein the first and second skin members comprise a compression molded polymer.

29. The trimmable door assembly of claim 23, wherein first and second skin members comprise plastic or polymer glass fiber reinforced door skins.

30. The trimmable door assembly of claim 29, wherein the first and second skin members further comprise a material selected from the list consisting of calcium carbonate, chopped fiber strands, and pigment.

31. The trimmable door assembly of claim 23, wherein the foam core comprises a foamed-in-place material.

32. The trimmable door assembly of claim 23, wherein the foam core comprises polyurethane or styrene foam.

33. The trimmable door assembly of claim 23, wherein the first and second composite stiles each comprises a plurality of recesses configured to receive respective beads of adhesive material to adhere the first and second stiles to the first and second skin members.
